(19) United States
(12) Patent Application Publication
(10) Pub. No.: US 2020/0288146 A1
(43) Pub. Date: Sep. 10, 2020

(54) INTRA-PREDICTION MODE-BASED IMAGE PROCESSING METHOD AND APPARATUS THEREFOR

(71) Applicant: LG Electronics Inc., Seoul (KR)

(72) Inventors: Yongjoon JEON, Seoul (KR); Jin HEO, Seoul (KR); Sunmi YOO, Seoul (KR)

(21) Appl. No.: 15/932,376

(22) PCT Filed: May 2, 2016
(86) PCT No.: PCT/KR2016/004611

§ 371 Date: Feb. 16, 2018

Related U.S. Application Data
(60) Provisional application No. 62/206,259, filed on Aug. 17, 2015.

(51) Int. Cl. H04N 19/159; H04N 19/176; H04N 19/105; H04N 19/117

(52) U.S. Cl. CPC H04N 19/159; H04N 19/117; H04N 19/105; H04N 19/176

(57) ABSTRACT

An image processing method based on an intra-prediction mode and an apparatus for the same. Particularly, the method may include deriving an intra-prediction mode of a current block, constructing a reference sample to be used for a prediction of the current block from a neighboring sample of the current block, generating a prediction block of the current block based on the intra-prediction mode by using the reference sample, and performing a post filtering by using an adjacent sample of the prediction sample for each prediction sample in the prediction block.

### TECHNICAL FIELD

The present invention relates to a still image or moving image processing method and, more particularly, to a method of encoding/decoding a still image or moving image based on an intra-prediction mode and an apparatus supporting the same.

### BACKGROUND ART

A compression encoding means a series of signal processing techniques for transmitting digitized information through a communication line or techniques for storing the information in a form that is proper for a storage medium. The media including a picture, an image, an audio, and the like may be the target for the compression encoding, and particularly, the technique of performing the compression encoding targeted to the picture is referred to as a video image compression.

The next generation video contents are supposed to have the characteristics of high spatial resolution, high frame rate and high dimensionality of scene representation. In order to process such contents, drastic increase of memory storage, memory access rate and processing power will be resulted.

Accordingly, it is required to design the coding tool for processing the next generation video contents efficiently.

### DISCLOSURE

### Technical Problem

An object of the present invention is to provide a method of performing post filtering in an intra-predicted block in processing an image based on intra-prediction (or prediction in an image).

Technical objects to be achieved by the present invention are not limited to the aforementioned objects, and a person having ordinary skill in the art to which the present invention pertains may evidently understand other technological objects from the following description.

### TECHNICAL SOLUTION

According to an aspect of the present invention, a method for processing an image based on an intra-prediction mode may include deriving an intra-prediction mode of a current block; constructing a reference sample to be used for a prediction of the current block from a neighboring sample of the current block; generating a prediction block of the current block based on the intra-prediction mode by using the reference sample; and performing a post filtering by using an adjacent sample of a prediction sample for each prediction sample in the prediction block.

According to another aspect of the present invention, an apparatus for processing an image based on an intra-prediction mode may include a prediction mode derivation unit for deriving an intra-prediction mode of a current block; a reference sample construction unit for constructing a reference sample to be used for a prediction of the current block from a neighboring sample of the current block; a prediction block generation unit for generating a prediction block of the current block based on the intra-prediction mode by using the reference sample; and a post filtering unit for performing a post filtering by using an adjacent sample of the prediction sample for each prediction sample in the prediction block.

Preferably, a filter index from an encoding apparatus is received, and an adjacent sample used in the post filtering and/or a filter coefficient used in the post filtering may be determined depending on the filter index.

Preferably, an adjacent sample used in the post filtering and/or a filter coefficient used in the post filtering may be determined depending on the intra-prediction mode.

Preferably, the post filtering may be performed by using only a top adjacent sample of the prediction sample, when the intra-prediction mode is a horizontal mode.

Preferably, the post filtering may be performed by using only a left adjacent sample of the prediction sample, when the intra-prediction mode is a vertical mode.

Preferably, the information indicating whether to apply the post filtering to the current block is received, wherein whether to apply the post filtering to the current block may be determined according to the information.

Preferably, the post filtering may be performed by using a left adjacent sample and/or a top adjacent sample of the prediction sample.

Preferably, the adjacent sample used for the post filtering may be a sample before the post filtering is applied.

Preferably, the adjacent sample used for the post filtering is a sample to which the post filtering may be applied.

Preferably, the post filtering may be applied to the current block, when a size of the current block is greater than a predetermined size and/or when the intra-prediction mode is a directional mode.

Preferably, a filtering may be not applied to the reference sample, when the post filtering is applied to the current block.

Preferably, a filtering may not be applied to a left end sample and/or a top end sample within the prediction block even when the intra-prediction mode is DC mode, a horizontal mode or a vertical mode, when the post filtering is applied to the current block.

### TECHNICAL EFFECTS

According to the present invention, a filtering including adjacent sample value is applied for each sample in an intra-predicted block, and accordingly, a discontinuity occurred in a block boundary may be decreased and correlation with a neighboring sample may be increased.

In addition, according to the present invention, a filtering including neighboring sample value is applied for each sample in an intra-predicted block, and accordingly, a residual signal of a block in which intra-prediction is applied, and coding efficiency may be increased.

The technical effects of the present invention are not limited to the technical effects described above, and other technical effects not mentioned herein may be understood by those skilled in the art from the description below.

### DESCRIPTION OF DRAWINGS

The accompanying drawings, which are included herein as a part of the description for helping understanding of the present invention, provide embodiments of the present invention and describe the technical features of the present invention with the description below.

FIG. 1 is an embodiment to which the present invention is applied, and shows a schematic block diagram of an encoder in which the encoding of a still image or moving image signal is performed.

FIG. 2 is an embodiment to which the present invention is applied, and shows a schematic block diagram of a decoder in which the encoding of a still image or moving image signal is performed.

FIGS. 3A and 3B are diagrams for illustrating the split structure of a coding unit to which the present invention may be applied.

FIG. 4 is a diagram for illustrating a prediction unit to which the present invention may be applied.

FIG. 5 is an embodiment to which the present invention is applied and is a diagram illustrating an intra-prediction method.

FIG. 6 illustrates prediction directions according to intra-prediction modes.

FIGS. 7A and 7B illustrate a method for performing post filtering according to an embodiment of the present invention.

FIG. 8 illustrates an example in which a post filtering method is defined depending on an intra-prediction according to an embodiment of the present invention.

FIGS. 9A and 9B illustrate a method for performing a post filtering according to an embodiment of the present invention.

FIG. 10 illustrates a decoding procedure based on an intra-prediction mode to which a post filtering is applied according to an embodiment of the present invention.

FIG. 11 illustrates a decoding procedure based on an intra-prediction mode to which a post filtering is applied according to an embodiment of the present invention.

FIG. 12 illustrates a decoding procedure based on an intra-prediction mode to which a post filtering is applied according to an embodiment of the present invention.

FIG. 13 is a diagram illustrating an intra-prediction unit according to an embodiment of the present invention.

### MODE FOR INVENTION

Hereinafter, preferred embodiments of the present invention will be described by reference to the accompanying drawings. The description that will be described below with the accompanying drawings is to describe exemplary embodiments of the present invention, and is not intended to describe the only embodiment in which the present invention may be implemented. The description below includes particular details in order to provide perfect understanding of the present invention. However, it is understood that the present invention may be embodied without the particular details to those skilled in the art.

In some cases, in order to prevent the technical concept of the present invention from being unclear, structures or devices which are publicly known may be omitted, or may be depicted as a block diagram centering on the core functions of the structures or the devices.

Further, although general terms widely used currently are selected as the terms in the present invention as much as possible, a term that is arbitrarily selected by the applicant is used in a specific case. Since the meaning of the term will be clearly described in the corresponding part of the description in such a case, it is understood that the present invention will not be simply interpreted by the terms only used in the description of the present invention, but the meaning of the terms should be figured out.

Specific terminologies used in the description below may be provided to help the understanding of the present invention. Furthermore, the specific terminology may be modified into other forms within the scope of the technical concept of the present invention. For example, a signal, data, a sample, a picture, a frame, a block, etc., may be properly replaced and interpreted in each coding process.

Hereinafter, in this specification, a “processing unit” means a unit by which an encoding/decoding processing process, such as prediction, transform and/or quantization, is performed. Hereinafter, for convenience of description, a processing unit may also be called a “processing block” or “block.”

A processing unit may be construed as a meaning including a unit for a luma component and a unit for a chroma component. For example, a processing unit may correspond to a coding tree unit (CTU), a coding unit (CU), a prediction unit (PU) or a transform unit (TU).

Furthermore, a processing unit may be construed as a unit for a luma component or a unit for a chroma component. For example, a processing unit may correspond to a coding tree block (CTB), coding block (CB), prediction block (PB) or transform block (TB) for a luma component. Alternatively, a processing unit may correspond to a coding tree block (CTB), coding block (CB), prediction block (PB) or transform block (TB) for a chroma component. Furthermore, the present invention is not limited thereto, and a processing unit may be construed as a meaning including a unit for a luma component and a unit for a chroma component.

Furthermore, a processing unit is not essentially limited to a block of a square, but may have a polygon form having three or more vertexes.

Furthermore, hereinafter, in this specification, a pixel or pixel element is collected referred to as a sample. Furthermore, using a sample may mean using a pixel value or a pixel element value.

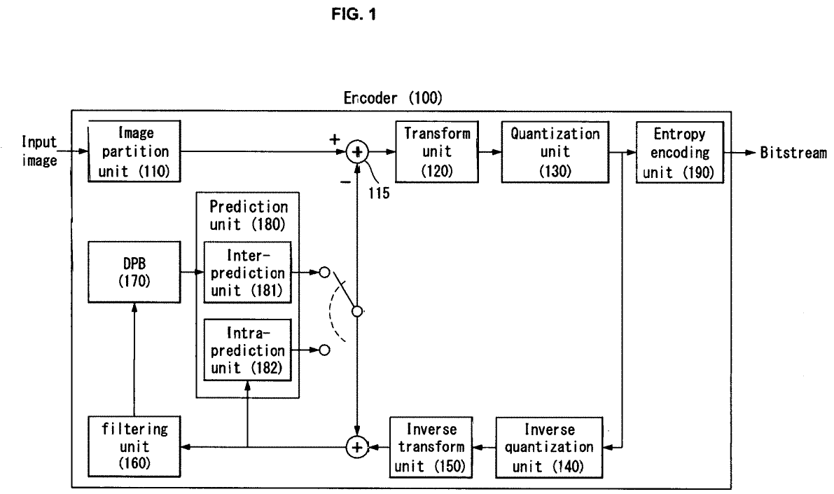

FIG. 1 is an embodiment to which the present invention is applied, and shows a schematic block diagram of an encoder in which the encoding of a still image or moving image signal is performed.

Referring to FIG. 1, an encoder 100 may include a picture split unit 110, a subtraction unit 115, a transform unit 120, a quantization unit 130, a dequantization unit 140, an inverse transform unit 150, a filtering unit 160, a decoded picture buffer (DPB) 170, a prediction unit 180 and an entropy encoding unit 190. Furthermore, the prediction unit 180 may include an inter-prediction unit 181 and an intra-prediction unit 182.

The video split unit 110 splits an input video signal (or picture or frame), input to the encoder 100, into one or more processing units.

The subtractor 115 generates a residual signal (or residual block) by subtracting a prediction signal (or prediction block), output by the prediction unit 180 (i.e., inter-prediction unit 181 or intra-prediction unit 182), from the input video signal. The generated residual signal (or residual block) is transmitted to the transform unit 120.

The transform unit 120 generates transform coefficients by applying a transform scheme (e.g., discrete cosine transform (DCT), discrete sine transform (DST), graph-based transform (GBT) or Karhunen-Loeve transform (KLT)) to the residual signal (or residual block). In this case, the transform unit 120 may generate the transform coefficients by performing transform using a determined transform scheme depending on a prediction mode applied to the residual block and the size of the residual block.

The quantization unit 130 quantizes the transform coefficient and transmits it to the entropy encoding unit 190, and the entropy encoding unit 190 performs an entropy coding operation of the quantized signal and outputs it as a bit stream.

Meanwhile, the quantized signal that is outputted from the quantization unit 130 may be used for generating a prediction signal. For example, by applying dequantization and inverse transformation to the quantized signal through the dequantization unit 140 and the inverse transform unit 150, the residual signal may be reconstructed. By adding the reconstructed residual signal to the prediction signal that is outputted from the inter-prediction unit 181 or the intra-prediction unit 182, a reconstructed signal may be generated.

Meanwhile, during such a compression process, adjacent blocks are quantized by different quantization parameters from each other, and accordingly, an artifact in which block boundaries are shown may occur. Such a phenomenon is referred to blocking artifact, which is one of the important factors for evaluating image quality. In order to decrease such an artifact, a filtering process may be performed. Through such a filtering process, the blocking artifact is removed and the error for the current picture is decreased at the same time, thereby the image quality being improved.

The filtering unit 160 applies filtering to the reconstructed signal, and outputs it through a play-back device or transmits it to the decoded picture buffer 170. The filtered signal transmitted to the decoded picture buffer 170 may be used as a reference picture in the inter-prediction unit 181. As such, by using the filtered picture as a reference picture in an inter-picture prediction mode, the encoding rate as well as the image quality may be improved.

The decoded picture buffer 170 may store the filtered picture in order to use it as a reference picture in the inter-prediction unit 181

The inter-prediction unit 181 performs a temporal prediction and/or a spatial prediction by referencing the reconstructed picture in order to remove a temporal redundancy and/or a spatial redundancy. In this case, since the reference picture used for performing a prediction is a transformed signal that goes through the quantization or the dequantization by a unit of block when being encoded/decoded previously, there may exist blocking artifact or ringing artifact.

Accordingly, in order to solve the performance degradation owing to the discontinuity of such a signal or the quantization, by applying a low pass filter to the inter-prediction unit 181, the signals between pixels may be interpolated by a unit of sub-pixel. Herein, the sub-pixel means a virtual pixel that is generated by applying an interpolation filter, and an integer pixel means an actual pixel that is existed in the reconstructed picture. As a method of interpolation, a linear interpolation, a bi-linear interpolation, a wiener filter, and the like may be applied.

The interpolation filter may be applied to the reconstructed picture, and may improve the accuracy of prediction. For example, the inter-prediction unit 181 may perform prediction by generating an interpolation pixel by applying the interpolation filter to the integer pixel, and by using the interpolated block that includes interpolated pixels as a prediction block.

The intra-prediction unit 182 predicts the current block by referring to the samples adjacent the block that is to be encoded currently. The intra-prediction unit 182 may perform the following procedure in order to perform the intra-prediction. First, the intra-prediction unit 182 may prepare a reference sample that is required for generating a prediction signal. Furthermore, the intra-prediction unit 182 may generate a prediction signal by using the reference sample prepared. Also, the intra-prediction unit 182 may encode the prediction mode. In this case, the reference sample may be prepared through reference sample padding and/or reference sample filtering. Since the reference sample goes through the prediction and the reconstruction process, there may be a quantization error. Accordingly, in order to decrease such an error, the reference sample filtering process may be performed for each prediction mode that is used for the intra-prediction.

The prediction signal (or prediction block) generated through the inter-prediction unit 181 or the intra-prediction unit 182 may be used to generate a reconstructed signal (or reconstructed block) or may be used to generate a residual signal (or residual block).

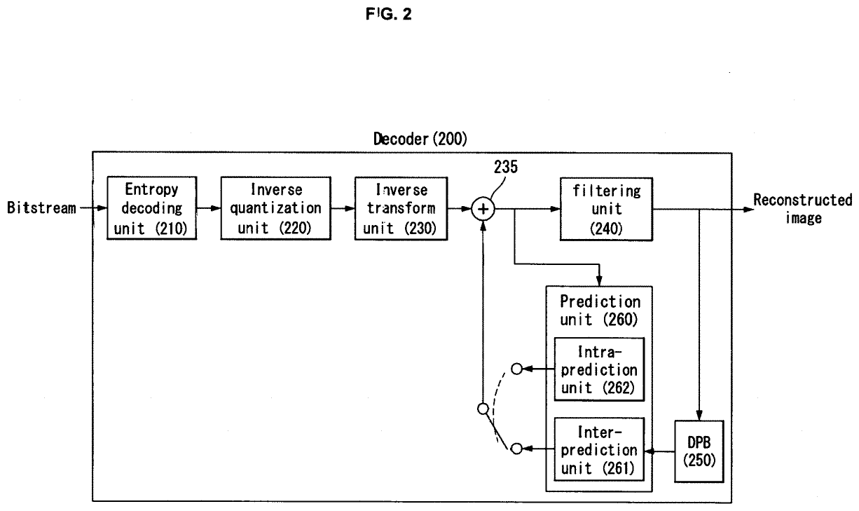

FIG. 2 is an embodiment to which the present invention is applied, and shows a schematic block diagram of a decoder in which the encoding of a still image or moving image signal is performed.

Referring to FIG. 2, a decoder 200 may include an entropy decoding unit 210, a dequantization unit 220, an inverse transform unit 230, an addition unit 235, a filtering unit 240, a decoded picture buffer (DPB) 250 and a prediction unit 260. Furthermore, the prediction unit 260 may include an inter-prediction unit 261 and an intra-prediction unit 262.

Furthermore, the reconstructed video signal outputted through the decoder 200 may be played through a play-back device.

The decoder 200 receives the signal (i.e., bit stream) outputted from the encoder 100 shown in FIG. 1, and the entropy decoding unit 210 performs an entropy decoding operation of the received signal.

The dequantization unit 220 acquires a transform coefficient from the entropy-decoded signal using quantization step size information.

The inverse transform unit 230 obtains a residual signal (or residual block) by inversely transforming transform coefficients using an inverse transform scheme.

The adder 235 adds the obtained residual signal (or residual block) to the prediction signal (or prediction block) output by the prediction unit 260 (i.e., inter-prediction unit 261 or intra-prediction unit 262), thereby generating a reconstructed signal (or reconstructed block).

The filtering unit 240 applies filtering to the reconstructed signal (or reconstructed block) and outputs it to a playback device or transmits it to the decoding picture buffer unit 250. The filtered signal transmitted to the decoding picture buffer unit 250 may be used as a reference picture in the inter-prediction unit 261.

In this specification, the embodiments described in the filtering unit 160, the inter-prediction unit 181 and the intra-prediction unit 182 of the encoder 100 may also be applied to the filtering unit 240, the inter-prediction unit 261 and the intra-prediction unit 262 of the decoder, respectively, in the same way.

Processing Unit Split Structure

In general, the block-based image compression method is used in a technique (e.g., HEVC) for compressing a still image or a moving image. A block-based image compression method is a method of processing a video by splitting the video into specific block units, and may decrease the capacity of memory and a computational load.

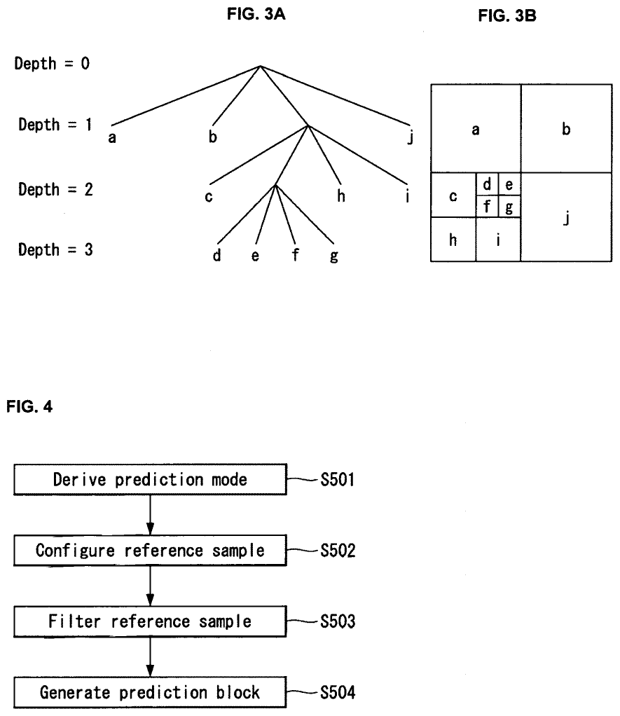

FIGS. 3A and 3B are diagrams for illustrating the split structure of a coding unit that may be applied to the present invention.

The encoder splits a single image (or picture) in a coding tree unit (CTU) of a rectangle form, and sequentially encodes a CTU one by one according to raster scan order.

In HEVC, the size of a CTU may be determined to be one of 64×64, 32×32 and 16×16. The encoder may select and use the size of CTU according to the resolution of an input video or the characteristics of an input video. A CTU includes a coding tree block (CTB) for a luma component and a CTB for two chroma components corresponding to the luma component.

One CTU may be split in a quad-tree structure. That is, one CTU may be split into four units, each having a half horizontal size and half vertical size while having a square form, thereby being capable of generating a coding unit (CU). The split of the quad-tree structure may be recursively performed. That is, a CU is hierarchically from one CTU in a quad-tree structure.

A CU means a basic unit for a processing process of an input video, for example, coding in which intra/inter prediction is performed. A CU includes a coding block (CB) for a luma component and a CB for two chroma components corresponding to the luma component. In HEVC, the size of a CU may be determined to be one of 64×64, 32×32, 16×16 and 8×8.

Referring to FIG. 3A, a root node of a quad-tree is related to a CTU. The quad-tree is split until a leaf node is reached, and the leaf node corresponds to a CU.

This is described in more detail. A CTU corresponds to a root node and has the deepest depth (i.e., depth=0) value. A CTU may not be split depending on the characteristics of an input video. In this case, the CTU corresponds to a CU.

A CTU may be split in a quad-tree form. As a result, lower nodes of a depth 1 (depth=1) are generated. Furthermore, a node (i.e., a leaf node) no longer split from the lower node having the depth of 1 corresponds to a CU. For example, in FIG. 3B, a CU(a), CU(b) and CU(j) corresponding to nodes a, b and j have been once split from a CTU, and have a depth of 1.

At least one of the nodes having the depth of 1 may be split in a quad-tree form again. As a result, lower nodes of a depth 2 (i.e., depth=2) are generated. Furthermore, a node (i.e., leaf node) no longer split from the lower node having the depth of 2 corresponds to a CU. For example, in FIG. 3B, a CU(c), CU(h) and CU(i) corresponding to nodes c, h and i have been twice split from the CTU, and have a depth of 2.

Furthermore, at least one of the nodes having the depth of 2 may be split in a quad-tree form again. As a result, lower nodes having a depth of 3 (i.e., depth=3) are generated. Furthermore, a node (i.e., leaf node) no longer split from the lower node having the depth of 3 corresponds to a CU. For example, in FIG. 3B, a CU(d), CU(e), CU(f) and CU(g) corresponding to nodes d, e, f and g have been split from the CTU three times, and have a depth of 3.

In the encoder, a maximum size or minimum size of a CU may be determined according to the characteristics of a video image (e.g., resolution) or by considering encoding rate. Furthermore, information about the size or information capable of deriving the size may be included in a bit stream. A CU having a maximum size is referred to as the largest coding unit (LCU), and a CU having a minimum size is referred to as the smallest coding unit (SCU).

In addition, a CU having a tree structure may be hierarchically split with predetermined maximum depth information (or maximum level information). Furthermore, each split CU may have depth information. Since the depth information represents the split count and/or degree of a CU, the depth information may include information about the size of a CU.

Since the LCU is split in a quad-tree form, the size of the SCU may be obtained using the size of the LCU and maximum depth information. Alternatively, the size of the LCU may be obtained using the size of the SCU and maximum depth information of a tree.

For a single CU, information (e.g., a split CU flag (split_cu_flag)) indicating whether the corresponding CU is split may be forwarded to the decoder. The split information is included in all of CUs except the SCU. For example, when the value of the flag indicating whether to split is ‘1’, the corresponding CU is further split into four CUs, and when the value of the flag that represents whether to split is ‘0’, the corresponding CU is not split any more, and the processing process for the corresponding CU may be performed.

As described above, the CU is a basic unit of the coding in which the intra-prediction or the inter-prediction is performed. The HEVC splits the CU in a prediction unit (PU) for coding an input video more effectively.

The PU is a basic unit for generating a prediction block, and even in a single CU, the prediction block may be generated in different way by a unit of a PU. However, the intra-prediction and the inter-prediction are not used together for the PUs that belong to a single CU, and the PUs that belong to a single CU are coded by the same prediction method (i.e., intra-prediction or the inter-prediction).

The PU is not split in the Quad-tree structure, but is split once in a single CU in a predetermined form. This will be described by reference to the drawing below.

FIG. 4 is a diagram for illustrating a prediction unit that may be applied to the present invention.

A PU is differently split depending on whether the intra-prediction mode is used or the inter-prediction mode is used as the coding mode of the CU to which the PU belongs.

FIG. 4(a) illustrates a PU of the case where the intra-prediction mode is used, and FIG. 4(b) illustrates a PU of the case where the inter-prediction mode is used.

Referring to FIG. 4(a), assuming the case where the size of a single CU is 2N×2N (N=4, 8, 16 and 32), a single CU may be split into two types (i.e., 2N×2N or N×N).

In this case, in the case where a single CU is split into the PU of 2N×2N form, it means that only one PU is existed in a single CU.

In contrast, in the case where a single CU is split into the PU of N×N form, a single CU is split into four PUs, and different prediction blocks are generated for each PU unit. However, such a PU split may be performed only in the case where the size of a CB for the luma component of a CU is a minimum size (i.e., if a CU is the SCU).

Referring to FIG. 4(b), assuming that the size of a single CU is 2N×2N (N=4, 8, 16 and 32), a single CU may be split into eight PU types (i.e., 2N×2N, N×N, 2N×N, N×2N, nL×2N, nR×2N, 2N×nU and 2N×nD)

As in intra-prediction, the PU split of N×N form may be performed only in the case where the size of a CB for the luma component of a CU is a minimum size (i.e., if a CU is the SCU).

Inter-prediction supports the PU split of a 2N×N form in the horizontal direction and an N×2N form in the vertical direction.

In addition, the inter-prediction supports the PU split in the form of nL×2N, nR×2N, 2N×nU and 2N×nD, which is asymmetric motion split (AMP). In this case, ‘n’ means ¼ value of 2N. However, the AMP may not be used in the case where a CU to which a PU belongs is a CU of minimum size.

In order to efficiently encode an input video in a single CTU, the optimal split structure of a coding unit (CU), prediction unit (PU) and transform unit (TU) may be determined based on a minimum rate-distortion value through the processing process as follows. For example, as for the optimal CU split process in a 64×64 CTU, the rate-distortion cost may be calculated through the split process from a CU of a 64×64 size to a CU of an 8×8 size. A detailed process is as follows.

1) The optimal split structure of a PU and TU that generates a minimum rate distortion value is determined by performing inter/intra-prediction, transformation/quantization, dequantization/inverse transformation and entropy encoding on a CU of a 64×64 size.

2) The optimal split structure of a PU and TU is determined by splitting a 64×64 CU into four CUs of a 32×32 size and generating a minimum rate distortion value for each 32×32 CU.

3) The optimal split structure of a PU and TU is determined by further splitting a 32×32 CU into four CUs of a 16×16 size and generating a minimum rate distortion value for each 16×16 CU.

4) The optimal split structure of a PU and TU is determined by further splitting a 16×16 CU into four CUs of an 8×8 size and generating a minimum rate distortion value for each 8×8 CU.

5) The optimal split structure of a CU in a 16×16 block is determined by comparing the rate-distortion value of the 16×16 CU obtained in the process of 3) with the addition of the rate-distortion value of the four 8×8 CUs obtained in the process of 4). This process is also performed on the remaining three 16×16 CUs in the same manner.

6) The optimal split structure of a CU in a 32×32 block is determined by comparing the rate-distortion value of the 32×32 CU obtained in the process of 2) with the addition of the rate-distortion value of the four 16×16 CUs obtained in the process of 5). This process is also performed on the remaining three 32×32 CUs in the same manner.

7) Lastly, the optimal split structure of a CU in a 64×64 block is determined by comparing the rate-distortion value of the 64×64 CU obtained in the process of 1) with the addition of the rate-distortion value of the four 32×32 CUs obtained in the process of 6).

In an intra-prediction mode, a prediction mode is selected in a PU unit, and prediction and reconstruction are performed on the selected prediction mode in an actual TU unit.

A TU means a basic unit by which actual prediction and reconstruction are performed. A TU includes a transform block (TB) for a luma component and two chroma components corresponding to the luma component.

In the example of FIGS. 3A and 3B, as if one CTU is split in a quad-tree structure to generate a CU, a TU is hierarchically split from one CU to be coded in a quad-tree structure.

A TU is split in the quad-tree structure, and a TU split from a CU may be split into smaller lower TUs. In HEVC, the size of a TU may be determined to be any one of 32×32, 16×16, 8×8 and 4×4.

Referring back to FIGS. 3A and 3B, it is assumed that the root node of the quad-tree is related to a CU. The quad-tree is split until a leaf node is reached, and the leaf node corresponds to a TU.

This is described in more detail. A CU corresponds to a root node and has the deepest depth (i.e., depth=0) value. A CU may not be split depending on the characteristics of an input video. In this case, the CU corresponds to a TU.

A CU may be split in a quad-tree form. As a result, lower nodes, that is, a depth 1 (depth=1), are generated. Furthermore, a node (i.e., leaf node) no longer split from the lower node having the depth of 1 corresponds to a TU. For example, in FIG. 3B, a TU(a), TU(b) and TU(j) corresponding to the nodes a, b and j have been once split from a CU, and have a depth of 1.

At least one of the nodes having the depth of 1 may be split again in a quad-tree form. As a result, lower nodes, that is, a depth 2 (i.e., depth=2), are generated. Furthermore, a node (i.e., leaf node) no longer split from the lower node having the depth of 2 corresponds to a TU. For example, in FIG. 3B, a TU(c), TU(h) and TU(i) corresponding to the nodes c, h and i have been split twice from the CU, and have a depth of 2.

Furthermore, at least one of the nodes having the depth of 2 may be split in a quad-tree form again. As a result, lower nodes having a depth of 3 (i.e., depth=3) are generated. Furthermore, a node (i.e., leaf node) no longer split from a lower node having the depth of 3 corresponds to a CU. For example, in FIG. 3B, a TU(d), TU(e), TU(f), TU(g) corresponding to the nodes d, e, f and g have been split from the CU three times, and have the depth of 3.

A TU having a tree structure may be hierarchically split based on predetermined highest depth information (or highest level information). Furthermore, each split TU may have depth information. The depth information may also include information about the size of the TU because it indicates the number of times and/or degree that the TU has been split.

With respect to one TU, information (e.g., a split TU flag (split_transform_flag)) indicating whether a corresponding TU has been split may be transferred to the decoder. The split information is included in all TUs other than a TU of the least size. For example, if the value of the flag indicating whether a TU has been split is ‘1’, the corresponding TU is split into four TUs. If the value of the flag ‘0’, the corresponding TU is no longer split.

Prediction

In order to reconstruct a current processing unit on which decoding is performed, the decoded part of a current picture including the current processing unit or other pictures may be used.

A picture (slice) using only a current picture for reconstruction, that is, performing only intra-prediction, may be referred to as an intra-picture or I picture (slice). A picture (slice) using the greatest one motion vector and reference index in order to predict each unit may be referred to as a predictive picture or P picture (slice). A picture (slice) using a maximum of two motion vectors and reference indices in order to predict each unit may be referred to as a bi-predictive picture or B picture (slice).

Intra-prediction means a prediction method of deriving a current processing block from a data element (e.g., sample value, etc.) of the same decoded picture (or slice). That is, intra-prediction means a method of predicting a pixel value of the current processing block with reference to reconstructed regions within a current picture.

Inter-prediction means a prediction method of deriving a current processing block based on a data element (e.g., sample value or motion vector) of a picture other than a current picture. That is, inter-prediction means a method of predicting the pixel value of the current processing block with reference to reconstructed regions within another reconstructed picture other than a current picture.

Hereinafter, intra-prediction is described in more detail.

Intra-Prediction

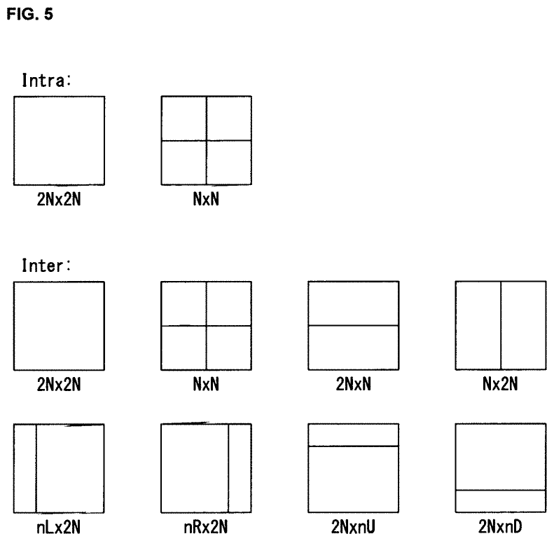

FIG. 5 is an embodiment to which the present invention is applied and is a diagram illustrating an intra-prediction method.

Referring to FIG. 5, the decoder derives an intra-prediction mode of a current processing block (S501).

In intra-prediction, there may be a prediction direction for the location of a reference sample used for prediction depending on a prediction mode. An intra-prediction mode having a prediction direction is referred to as intra-angular prediction mode “Intra_Angular prediction mode.” In contrast, an intra-prediction mode not having a prediction direction includes an intra-planar (INTRA_PLANAR) prediction mode and an intra-DC (INTRA_DC) prediction mode.

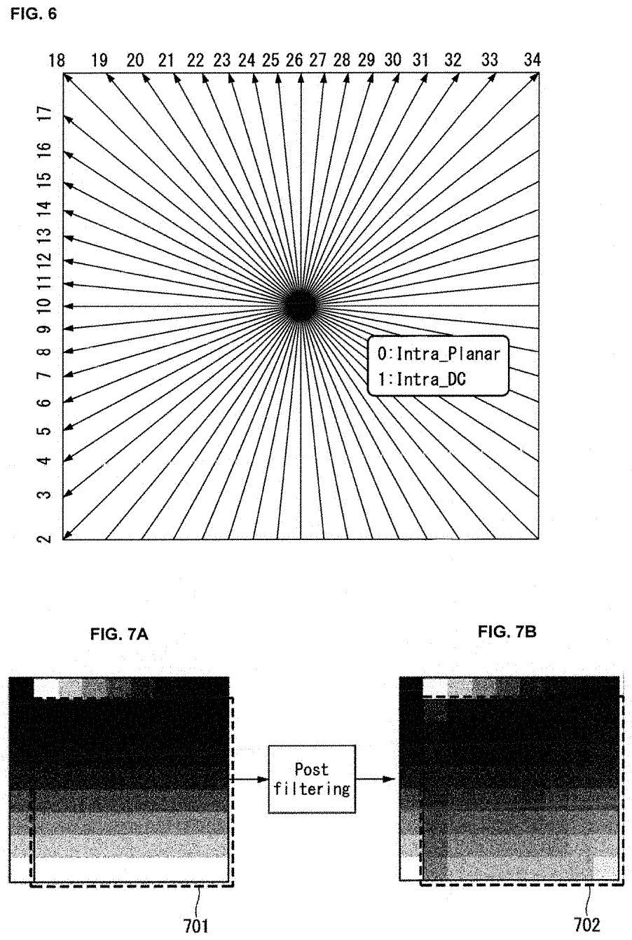

Table 1 illustrates intra-prediction modes and associated names, and FIG. 6 illustrates prediction directions according to intra-prediction modes.

TABLE 1

| INTRA | |
|---|---|
| PREDICTION MODE | ASSOCIATED NAMES |
| 0 | INTRA_PLANAR |
| 1 | INTRA_DC |
| 2 . . . 34 | INTRA_ANGULAR2 . . . INTRA_ANGULAR34 |

In intra-prediction, prediction may be on a current processing block based on a derived prediction mode. A reference sample used for prediction and a detailed prediction method are different depending on a prediction mode. Accordingly, if a current block is encoded in an intra-prediction mode, the decoder derives the prediction mode of a current block in order to perform prediction.

The decoder checks whether neighboring samples of the current processing block may be used for prediction and configures reference samples to be used for prediction (S502).

In intra-prediction, neighboring samples of a current processing block mean a sample neighboring the left boundary of the current processing block of an nS×nS size, a total of 2×nS samples neighboring the left bottom of the current processing block, a sample neighboring the top boundary of the current processing block, a total of 2×nS samples neighboring the top right of the current processing block, and one sample neighboring the top left of the current processing block.

However, some of the neighboring samples of the current processing block have not yet been decoded or may not be available. In this case, the decoder may configure reference samples to be used for prediction by substituting unavailable samples with available samples.

The decoder may perform the filtering of the reference samples based on the intra-prediction mode (S503).

Whether the filtering of the reference samples will be performed may be determined based on the size of the current processing block. Furthermore, a method of filtering the reference samples may be determined by a filtering flag transferred by the encoder.

The decoder generates a prediction block for the current processing block based on the intra-prediction mode and the reference samples (S504). That is, the decoder generates the prediction block for the current processing block (i.e., generates a prediction sample within the current processing block) based on the intra-prediction mode derived in the intra-prediction mode derivation step S501 and the reference samples obtained through the reference sample configuration step S502 and the reference sample filtering step S503.

If the current processing block has been encoded in the INTRA_DC mode, in order to minimize the discontinuity of the boundary between processing blocks, at step S504, the left boundary sample of the prediction block (i.e., a sample within the prediction block neighboring the left boundary) and the top boundary sample (i.e., a sample within the prediction block neighboring the top boundary) may be filter.

Furthermore, at step S504, in the vertical mode and horizontal mode of the intra-angular prediction modes, as in the INTRA_DC mode, filtering may be applied to the left boundary sample or the top boundary sample.

This is described in more detail. If the current processing block has been encoded in the vertical mode or the horizontal mode, the value of a prediction sample may be derived based on a reference sample located in a prediction direction. In this case, a boundary sample that belongs to the left boundary sample or top boundary sample of the prediction block and that is not located in the prediction direction may neighbor a reference sample not used for prediction. That is, the distance from the reference sample not used for prediction may be much closer than the distance from the reference sample used for prediction.

Accordingly, the decoder may adaptively apply filtering on left boundary samples or top boundary samples depending on whether an intra-prediction direction is a vertical direction or a horizontal direction. That is, the decoder may apply filtering on the left boundary samples if the intra-prediction direction is the vertical direction, and may apply filtering on the top boundary samples if the intra-prediction direction is the horizontal direction.

Image Processing Method Based on Intra-Prediction Mode

The conventional intra-prediction (or prediction within an image) uses a value of sample adjacent to a left side and/or a top end as a prediction value of a current block. In this case, a discontinuity may occur in the current block boundary, and a correlation is degraded and residual may be increased as being farther away from an adjacent sample.

The present invention proposes to perform a post filtering on a predicted block within an image for improving intra-prediction performance. In addition, the present invention proposes an additional method for further improving a performance of post filtering which is proposed in the present invention. That is, the present invention proposes a method of reflecting neighboring sample values through post filtering, which has not been reflected by the conventional intra-prediction method.

Embodiment 1

FIGS. 7A and 7B illustrate a method for performing post filtering according to an embodiment of the present invention.

FIG. 7A illustrates a prediction block 701 generated through an intra-prediction, and FIG. 7B illustrates a prediction block 702 to which the post filtering is applied.

In the case that an intra-prediction mode of a horizontal direction is applied as shown in FIG. 7A, a predicted sample of the prediction block 701 is derived from a reference sample of a left side, but its own neighboring sample value is unable to be reflected on the predicted sample of the prediction block 701. Accordingly, as a distance from the reference sample increases (in FIGS. 7A and 7B, as a sample locates close to a right side in the prediction block 701), correlation with the reference sample becomes degraded, and there is disadvantage that residual value increases.

On the contrary, according to the present invention, post filtering is applied to each sample of the intra-predicted block 701, and the sample within the prediction block 702 to which the post filtering is applied is available to reflect its own neighboring sample value, and consequently, a residual value from an original block may be decreased.

For this purpose, the present invention proposes a method of applying post filtering using adjacent sample(s) for each sample of the prediction block 701 generated by an intra-prediction.

As an embodiment according to the present invention, adjacent samples (or neighboring samples) of a left side and/or a top of the current intra-predicted sample may be used for the post filtering.

Equation 1 below exemplifies 3-tap filtering by using a left adjacent sample and/or top adjacent samples.

P′[i,j]=(α*P[i,j]+β*P[i−1,j]+γ*P[i,j−1]+2)>>2 [Equation 1]

Referring to Equation 1, P[i, j] represents an intra-predicted sample, P[i−1, j] represents a left adjacent sample of the intra-predicted sample, P′[i, j−1] represents a top adjacent sample of the intra-predicted sample, and P′[i, j] represents a sample to which the post filtering is applied to the intra-predicted sample.

In addition, α, β and γ of Equation 1 are coefficients of a post filter, and may be configured as various filter sets as represented in Table 2 below.

TABLE 2

| Filter | | | | |
|---|---|---|---|---|
| Index | α | β | γ | Effect |
| 0 | 4 | 0 | 0 | No smoothing |
| 1 | 2 | 1 | 1 | Smoothing left and above |
| 2 | 2 | 2 | 0 | Smoothing with left boundary |
| 3 | 2 | 0 | 2 | Smoothing with above boundary |

Referring to Table 2, when the filter index is 0, both values of β and γ are 0, and the post filtering is not applied, and consequently, there is no smoothing effect.

When the filter index is 1, then both values of β and γ are 1, and the post filtering is applied by using a left adjacent sample and a top adjacent sample of the intra-predicted sample, and consequently, smoothing effect may be obtained in the left and upper boundaries.

When the filter index is 2, β value is 2 and γ value is 0, and the post filtering is applied by using a left adjacent sample of the intra-predicted sample, and consequently, smoothing effect may be obtained in the left boundary.

When the filter index is 3, β value is 0 and γ value is 1, and the post filtering is applied by using a top adjacent sample of the intra-predicted sample, and consequently, smoothing effect may be obtained in the upper boundary.

As such, by defining various filter sets for the post filtering, each area (e.g., a block) of an image may have different properties, and since a prediction block is changed depending on an intra-prediction mode of each area, an optimal filtering to a current block is performed.

For this, an encoder may determine a filter index which is optimal to the current block, and may transmit the determined filter index to a decoder.

The decoder may receive the filter index from the encoder, and may perform a post filtering on an intra-predicted block based on the received filter index. That is, by using a filter coefficient used for the post filtering determined depending on the filter index and/or an adjacent sample used for the post filtering, the decoder may perform the post filtering for each intra-predicted sample.

In the case of using the filter according to Table 2 above, four types of filters are used, and 2 bits are required for a filter index coding. A syntax element that indicates such a filtering index may be transmitted for each block (e.g., a unit of encoding, a unit of prediction or a unit of transform). As such, a filter individually applied to each block is determined, and an optimal post filtering may be performed for each block.

Meanwhile, in this embodiment, for the convenience of description, 3-tap filter is exemplified by using a left side adjacent sample and a top adjacent sample for the post filtering of the currently intra-predicted sample, but the present invention is not limited thereto. That is, for optimizing a post filtering, more adjacent samples (e.g., a left side adjacent sample, a top adjacent sample and a top left adjacent sample are used for the post filtering of the currently intra-predicted sample) may be used, and a length of great filter (e.g., 4-tap filter) may also be used, and accordingly, it is understood that an allocation of more filter indexes may be subdivided.

Embodiment 2

The method according to the first embodiment described above uses a plurality of bits (e.g., 2 bits in the case of Table 2) for transmitting an optimal filter index among a plurality of filters (e.g., 4 types of filters in the case of Table 2) for each of all blocks (e.g., a unit of encoding, a unit of prediction or a unit of transform).

This embodiment proposes a method for further decreasing a signaling overhead transmitted from an encoder in order to determine a filter coefficient in a decoder.

For example, in the case that an intra-prediction mode of a current block is a prediction mode of a vertical direction, a copy is made from a top reference sample in the vertical direction, it may be unnecessary the filtering that reflects a top adjacent sample. Likewise, in the case that an intra-prediction mode of a current block is a prediction mode of a horizontal direction, a copy is made from a left reference sample in the horizontal direction, it may be unnecessary the filtering that reflects a left adjacent sample.

According to the embodiment, for each intra-prediction mode (or for each intra-prediction mode group including one or more intra-prediction modes), an adjacent sample used in a post filtering and/or a filter coefficient used for the post filtering may be predefined.

And, an adjacent sample used for the post filtering applied to a current block and/or a filter coefficient used for the post filtering may be determined according to an intra-prediction mode of the current block.

In addition, in an encoder, only the information (e.g., a post filtering flag) that indicates whether the post filtering is applied for each block may be signaled to a decoder. Accordingly, the decoder may determine whether to apply the post filtering to the current block according to the information received from the encoder. For example, in the case that the post filtering flag indicates that the post filtering is applied to the current block, the decoder may perform a post filtering for each sample of the current block by using a predetermined adjacent sample and/or a filter coefficient depending on the intra-prediction mode of the current block. As such, an encoder may signal only the fact (on/off) on whether to apply the post filtering and use a fixed filter depending on the intra-prediction mode, and accordingly, signaling overhead may be decreased, and encoding performance may be increased.

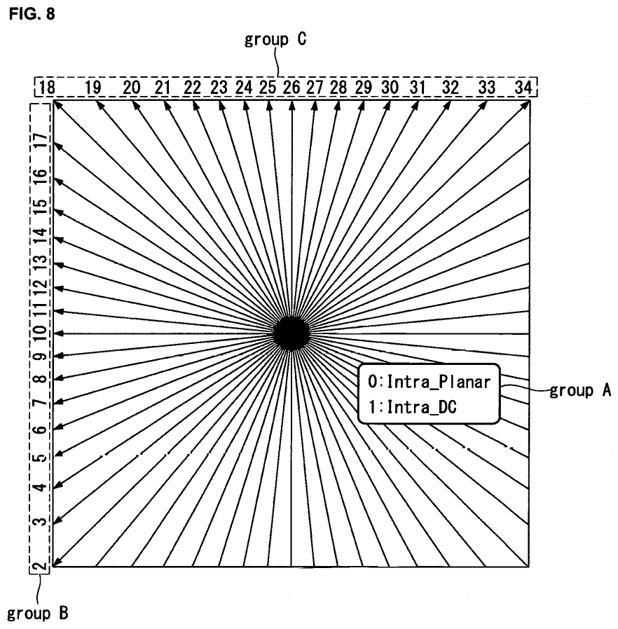

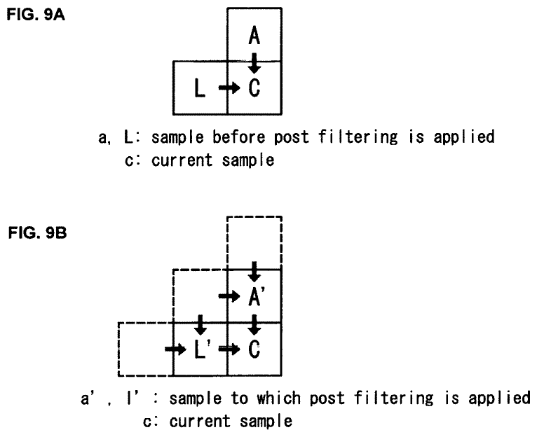

FIG. 8 illustrates an example in which a post filtering method is defined depending on an intra-prediction according to an embodiment of the present invention.

Referring to FIG. 8, intra-prediction modes may be grouped into a plurality of groups, and a filter index may be determined in advance for each group. Here, depending on the filter index, a neighboring sample and/or a filter coefficient used in a post filtering may be defined (refer to Table 2 above).

For example, filter index 1 may be allocated to group A (intra-prediction mode 0 (planar mode) and intra-prediction mode 1 (DC mode)), filter index 3 may be allocated to group B (intra-prediction mode 2 to intra-prediction mode 17), and filter index 2 may be allocated to group C (intra-prediction modes 18 to 34).

As such, depending on each intra-prediction mode, a filter index (i.e., filter coefficient and/or neighboring sample used in the post filtering) may be fixed, and since an encoder may transmit only the information on whether to use the post filtering, signaling overhead may be decreased in comparison with embodiment 1 above.

Meanwhile, in this embodiment, for the convenience of description, 3-tap filter is exemplified by using a left side adjacent sample and a top adjacent sample for the post filtering of the currently intra-predicted sample, but the present invention is not limited thereto. That is, for optimizing a post filtering, more adjacent samples (e.g., a left side adjacent sample, a top adjacent sample and a top left adjacent sample are used for the post filtering of the currently intra-predicted sample) may be used, and a length of great filter (e.g., 4-tap filter) may also be used, and accordingly, it is understood that an allocation of more filter indexes may be subdivided. Therefore, a filter index may be allocated by further subdividing the intra-prediction mode group or for each intra-prediction mode.

Meanwhile, as described in embodiment 1 or 2 above, when the post filtering is applied for each intra-predicted sample, in the case of a top-left sample of the current block, both of the top adjacent sample and the left adjacent sample correspond to reference samples. On the other hands, in the case of the other samples, the top adjacent sample and/or the left adjacent sample may correspond to a sample of the corresponding current sample. In this case, the sample value which is post filtered of the current sample may be different depending on whether the top adjacent sample and/or the left adjacent sample used for the post filtering of the current sample which is an application target for the post filtering is a sample to which the post filtering is applied.

In this case, the adjacent sample used for the post filtering of the current sample may be a sample to which the post filtering is not applied, but also may be a sample to which the post filtering is applied. This will be described with reference to the drawing below.

FIGS. 9A and 9B illustrate a method for performing a post filtering according to an embodiment of the present invention.

Referring to FIG. 9A, for the intra-predicted sample C which is a target of the post filtering currently, the post filtering is applied by using a top adjacent sample A and a left adjacent sample L. In this case, both of the top adjacent sample and the left adjacent sample may be samples to which the post filtering is not applied, that is, may correspond to inter-predicted samples. Accordingly, each of P[i−1, j] and P′[i, j−1] in Equation 1 above may mean an inter-predicted adjacent sample value to which the post filtering is not applied.

On the other hand, referring to FIG. 9B, for the intra-predicted sample C which is a target of the post filtering currently, the post filtering is applied by using a top adjacent sample A′ and a left adjacent sample L′. In this case, the top adjacent sample A′ is a sample to which the post filtering is applied by using a top adjacent sample and a left adjacent sample of the corresponding sample A′, and the left adjacent sample L′ is a sample to which the post filtering is applied by using a top adjacent sample and a left adjacent sample of the corresponding sample L′.

Accordingly, each of P[i−1, j] and P′[i, j−1] in Equation 1 above may mean an inter-predicted adjacent sample value to which the post filtering is applied.

In the meanwhile, for the convenience of description, embodiments 1 and 2 described above exemplifies a left adjacent sample and a top adjacent sample as an adjacent sample used for the post filtering of the current intra-predicted sample, but the present invention is not limited thereto.

By generalizing the example described above, the post filtering may be applied to an adjacent sample use for the post filtering of the current intra-predicted sample by using at least one of a left adjacent sample, a top adjacent sample, a right adjacent sample, a lower adjacent sample, a top left adjacent sample, a top right adjacent sample, a bottom left adjacent sample and a bottom light adjacent sample.

However, when the post filtering is applied for each sample of the current block according to z scan order, and in the case of using at least one of a right adjacent sample, a bottom left adjacent sample, a bottom adjacent sample and a bottom right adjacent sample, the adjacent sample value to which the post filtering is applied may not be used as shown in FIG. 8(b), but the adjacent sample value to which the post filtering is not applied may be used.

Embodiment 3

Hereinafter, this embodiment describes a method for generating an intra-prediction block based on the post filtering described in embodiment 1 or 2 above.

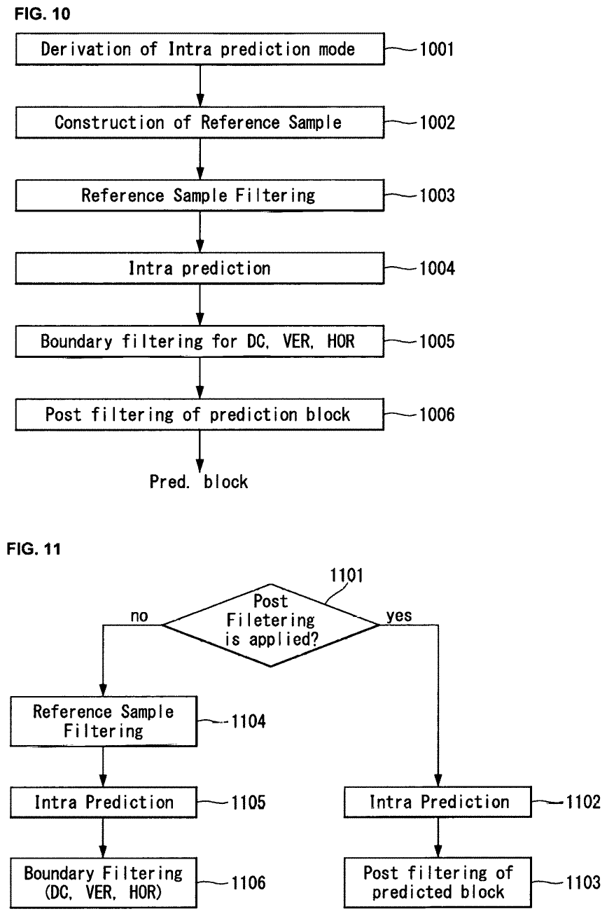

FIG. 10 illustrates a decoding procedure based on an intra-prediction mode to which a post filtering is applied according to an embodiment of the present invention.

Referring to FIG. 10, a decoder may derive an intra-prediction mode of a current block (step, S1001).

As described in Table 1 and FIG. 6 above, an intra-prediction may have a prediction direction with respect to a position of a reference sample used for prediction according to a prediction mode.

The decoder checks whether neighboring samples of the current block is used for a prediction, and constructs reference samples that are going to be used for the prediction (step, S1002).

In an intra-prediction, the neighboring samples of the current block (e.g., a unit of encoding, a unit of prediction or a unit of transform) may mean a sample adjacent to a left boundary of the current block of nS×nS size and total 2×nS samples neighboring a bottom-left, and total 2×nS samples neighboring a top-right and a single sample adjacent to a top boundary of the current block.

However, a part of the neighboring samples of the current block still may not be decoded or unavailable. In this case, the decoder may construct reference samples that are going to be used for a prediction by substituting the unavailable samples with available samples.

The decoder may perform a filtering of a reference sample (step, S1003).

The decoder may perform a filtering of a reference sample based on an intra-prediction mode.

In this case, it may be determined based on a size of the current process block whether to perform a filtering of a reference sample. In addition, the filtering method of one or more reference samples may be predefined, and it may be determined the filtering method of a reference sample by a filtering flag forwarded from an encoder.

The decoder generates a prediction block of the current block by using reference samples according to an intra-prediction mode of the current block (step, S1004).

That is, the decoder generates a prediction block for the current block (i.e., generates a sequence of prediction samples of the current block) based on the intra prediction mode derived in the step of deriving an intra-prediction mode (step, S1001) and the reference samples that are obtained through the step of constructing a reference sample (step, S1002) and the step of filtering a reference sample (step, S1003).

The decoder may perform a boundary filtering when the current block is encoded in INTRA_DC mode, a vertical mode or a horizontal mode (step, S1005).

In the case that the current block is encoded in the INTRA_DC mode, in order to minimize a discontinuity in the boundary between blocks, in step S1005, the decoder may perform filtering of a left boundary sample (i.e., a sample within a prediction block adjacent to a left boundary of the prediction block, that is, a left end sample within the prediction block) and a top boundary sample (i.e., a sample within a prediction block adjacent to a top boundary of the prediction block, that is, a top end sample within the prediction block).

In addition, in step S1005, the decoder may apply filtering to a left boundary sample or a top boundary sample similar to the INTRA_DC mode even for a vertical mode and a horizontal mode among intra-directional prediction modes. That is, when the intra-prediction direction is a vertical direction, filtering is applied to left boundary samples, and when the intra-prediction direction is a horizontal direction, filtering is applied to top boundary samples.

The decoder performs a post filtering of an intra-predicted block (step, S1006).

The decoder may generate a prediction block (i.e., a sequence of a prediction sample) of the current block finally by performing a post filtering for each sample within an intra-prediction bock by using the method described in embodiment 1 or embodiment 2 above.

For example, the decoder may perform a post filtering for each prediction sample within the current block by using an adjacent sample and/or a filter coefficient used for the post filtering which is determined according to the filter index received from an encoder as described in embodiment 1 above.

As another example, the decoder may perform a post filtering for each prediction sample within the current block by using an adjacent sample and/or a filter coefficient used for the post filtering which is determined according to an intra-prediction mode of the current block as described in embodiment 2 above. For example, when the intra-prediction mode is a horizontal mode, the post filtering may be performed by using a top adjacent sample of a prediction sample. Otherwise, when the intra-prediction mode is a vertical mode, the post filtering may be performed by using a left adjacent sample of a prediction sample.

Meanwhile, the method proposed in FIG. 10 may further optimize an encoding performance by applying the following method.

1) When the post filtering method proposed in the present invention is used, it may be helpful for improving performance not to use the reference sample filtering shown in FIG. 10 above. That is, in the case that the post filtering method proposed in the present invention is used, step S1002 in FIG. 10 above may be omitted.

2) When the post filtering method proposed in the present invention is used, it may be helpful for improving performance not to use the INTRA_DC mode, the boundary filtering used in the vertical mode or the horizontal mode shown in FIG. 10 above. That is, in the case that the post filtering method proposed in the present invention is used, step S1005 in FIG. 10 above may be omitted.

3) It may be determined whether to use the post filtering method proposed in the present invention depending on a size of a current block. For example, in the case that the size of the current block (e.g., a unit of encoding, a unit of prediction or a unit of transform) equals to or is smaller than a predetermined size (e.g., 4×4 or sum of width and height is 8), the post filtering method proposed in the present invention may not be performed. That is, step S1006 in FIG. 10 above may be omitted. In other words, the post filtering procedure proposed in the present invention may be performed only in the case that the size of the current block is greater than a predetermined size.

4) It may be determined whether to use the post filtering method proposed in the present invention depending on an intra-prediction mode of a current block. For example, in the case that the intra-prediction mode of the current block (e.g., a unit of encoding, a unit of prediction or a unit of transform) is INTRA_PLANAR or INTRA_DC, the post filtering method proposed in the present invention may not be performed. That is, step S1006 in FIG. 10 above may be omitted. In other words, the post filtering procedure proposed in the present invention may be performed only in the case that the intra-prediction mode of the current block is a directional mode.

5) An encoder may transmit a post filtering flag (e.g., postFilteringFlag) indicating whether to apply the post filtering method proposed in the present invention for each block (e.g., a unit of encoding, a unit of prediction or a unit of transform) to a decoder. That is, the decoder may decode the post filtering flag received from the encoder, and may determine whether to apply the post filtering on a current block depending on a value indicated by the post filtering flag.

Any one of the methods among methods 1) to 5) may be used, or two or more methods among methods 1) to 5) may be used in combination.

FIG. 11 illustrates a decoding procedure based on an intra-prediction mode to which a post filtering is applied according to an embodiment of the present invention.

In FIG. 11, for the convenience of description, it is assumed that the procedure of deriving an intra-prediction mode of a current block and the procedure of configuring a reference sample used in the intra-prediction based on a neighboring block of the current block are already performed.

Referring to FIG. 11, a decoder determines whether to apply the post filtering to a current block (step, S1101).

For example, the decoder may determine the post filtering to be applied when a size of the current block (e.g., a unit of prediction) is greater than a predetermined size (e.g., 4×4).

And/or the decoder may determine the post filtering to be applied when an intra-prediction mode of the current block is a predetermined mode (e.g., directional mode).

And, or, the decoder may determine the post filtering to be applied when a flag (e.g., postFilteringFlag) indicating whether to apply the post filtering received from an encoder indicates to apply the post filtering to the current block (e.g., postFilteringFlag=1).

As a result of the determination in step S1101, in the case that the post filtering is applied to the current block, the decoder generates a prediction block (i.e., generates a sequence of prediction samples of the current block) by using reference samples depending on an intra-prediction mode of the current block (step, S1102).

The decoder may perform the post filtering for each sample in an intra-prediction by using the method described above, and finally, may generate a prediction block (i.e., a sequence of prediction samples) of the current block (step, S1103).

For example, the decoder may perform the post filtering for each prediction sample in the current block by using an adjacent sample and/or a filter coefficient used for the post filtering which is determined according to the filter index received from the encoder as described in embodiment 1.

As another example, the decoder may perform the post filtering for each prediction sample in the current block by using an adjacent sample and/or a filter coefficient used for the post filtering which is determined according to the intra-prediction mode of the current block as described in embodiment 2.

On the other hand, as a result of the determination in step S1101, in the case that the post filtering is not applied to the current block, the decoder may perform a filtering of a reference sample (step, S1104).

The decoder may perform the filtering of the reference sample based on an intra-prediction mode.

In this case, it may be determined whether to perform the filtering of the reference sample based on a size of the current block. In addition, the filtering method of one or more reference samples is already defined, and it may be determined a filtering method of a type of reference sample by the filtering flag forwarded from the encoder.

The decoder generates a prediction block (i.e., generates a sequence of prediction samples of the current block) of the current block by using reference samples depending on an intra-prediction mode of the current block (step, S1105).

The decoder may perform a boundary filtering in the case that the current block is encoded in INTRA_DC mode, a vertical mode or a horizontal mode (step, S1106).

In the case that the current block is encoded in INTRA_DC mode, in order to minimize discontinuity in a boundary between blocks, the decoder may perform filtering of a left boundary sample (i.e., a sample in a prediction block adjacent to a left boundary of a prediction block, i.e., a left end sample in a prediction block) of a prediction block and a top boundary sample (i.e., a sample in a prediction block adjacent to a top boundary, i.e., a top end sample in a prediction block).

In addition, the decoder may also apply filtering to a left boundary sample or a top boundary sample similar to INTRA_DC mode for a vertical mode and a horizontal mode among the intra-directional prediction modes. That is, when an intra-prediction direction is a vertical direction, filtering is applied to left boundary samples, and when an intra-prediction direction is a horizontal direction, filtering is applied to top boundary samples.

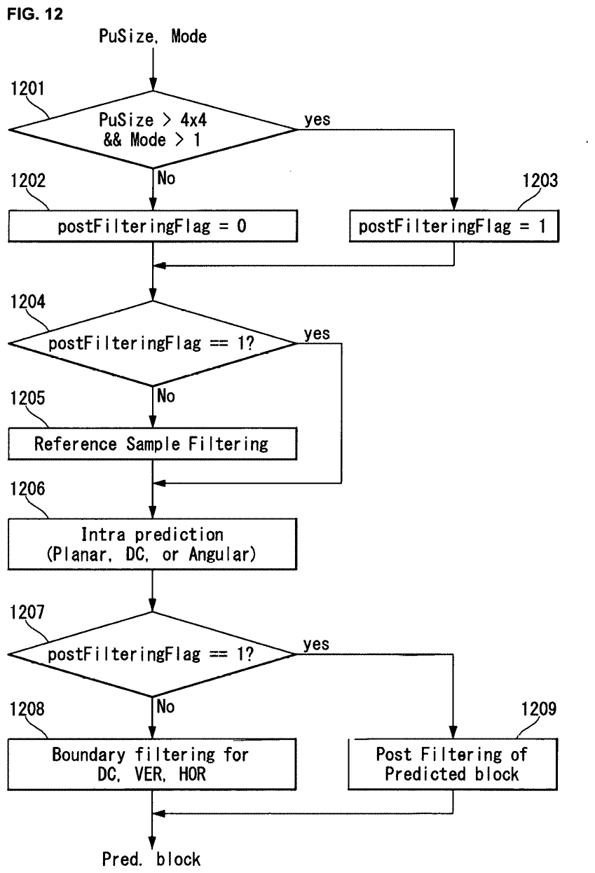

FIG. 12 illustrates a decoding procedure based on an intra-prediction mode to which a post filtering is applied according to an embodiment of the present invention.

In FIG. 12, for the convenience of description, it is assumed that the procedure of deriving an intra-prediction mode of a current block and the procedure of configuring a reference sample used in the intra-prediction based on a neighboring block of the current block are already performed.

Referring to FIG. 12, a decoder determines whether a size of a current unit of prediction is smaller than 4×4 and an intra-prediction mode of the current unit of prediction is greater than 1 (i.e., whether it is in a directional mode) (step, S1201).

As a result of the determination in step S1201, in the case that the current unit of prediction is smaller than 4×4 or an intra-prediction mode of the current unit of prediction is smaller than 1, the decoder sets a variable in relation to the post filtering (e.g., postFilteringFlag) to 0 (step, S1202).

On the contrary, as a result of the determination in step S1201, in the case that the current unit of prediction is smaller than 4×4 and an intra-prediction mode of the current unit of prediction is greater than 1, the decoder sets a variable in relation to the post filtering (e.g., postFilteringFlag) to 1 (step, S1203).

The decoder determines whether the variable in relation to the post filtering (e.g., postFilteringFlag) is 1 (step, S1204).

As a result of the determination in step S1204, in the case that the variable in relation to the post filtering (e.g., postFilteringFlag) is not 1, the decoder performs filtering of a reference sample (step, S1205).

The decoder may perform the filtering of the reference sample based on an intra-prediction mode.

In this case, it may be determined whether to perform the filtering of the reference sample based on a size of the current block. In addition, the filtering method of one or more reference samples is already defined, and it may be determined a filtering method of a type of reference sample by the filtering flag forwarded from the encoder.

The decoder generates a prediction block of the current block by using reference samples depending on an intra-prediction mode of the current block (step, S1206).

On the contrary, as a result of the determination in step S1204, in the case that the variable in relation to the post filtering (e.g., postFilteringFlag) is 1, the decoder does not perform filtering of a reference sample, but generates a prediction block of the current block by using references samples depending on an intra-prediction mode of the current block (step, S1206).

The decoder determines whether the variable in relation to the post filtering (e.g., postFilteringFlag) is 1 (step, S1207).

As a result of the determination in step S1207, in the case that the variable in relation to the post filtering (e.g., postFilteringFlag) is not 1, and in the case that the current block is encoded in INTRA_DC mode, a vertical mode or a horizontal mode, the decoder performs a boundary filtering (step, S1208).

In the case that the current block is encoded in INTRA_DC mode, in order to minimize discontinuity in a boundary between blocks, the decoder may perform filtering of a left boundary sample (i.e., a sample in a prediction block adjacent to a left boundary of a prediction block, i.e., a left end sample in a prediction block) of a prediction block and a top boundary sample (i.e., a sample in a prediction block adjacent to a top boundary, i.e., a top end sample in a prediction block).

In addition, the decoder may also apply filtering to a left boundary sample or a top boundary sample similar to INTRA_DC mode for a vertical mode and a horizontal mode among the intra-directional prediction modes. That is, when an intra-prediction direction is a vertical direction, filtering is applied to left boundary samples, and when an intra-prediction direction is a horizontal direction, filtering is applied to top boundary samples.

As a result of the determination in step S1207, in the case that the variable in relation to the post filtering (e.g., postFilteringFlag) is 1, the decoder performs the post filtering for each sample in an intra-prediction block by using the method described above (step, S1209).

For example, the decoder may perform the post filtering for each prediction sample in the current block by using an adjacent sample and/or a filter coefficient used for the post filtering which is determined according to the filter index received from the encoder as described in embodiment 1.

As another example, the decoder may perform the post filtering for each prediction sample in the current block by using an adjacent sample and/or a filter coefficient used for the post filtering which is determined according to the intra-prediction mode of the current block as described in embodiment 2.

As such, when the post filtering is applied to the current block, the prediction block (i.e., a sequence of prediction samples) in which the post filtering is performed as described in step S1209 may be finally generated, and when the post filtering is not applied to the current block, the prediction block (i.e., a sequence of prediction samples) in which the boundary filtering is performed as described in step S1208 may be finally generated.

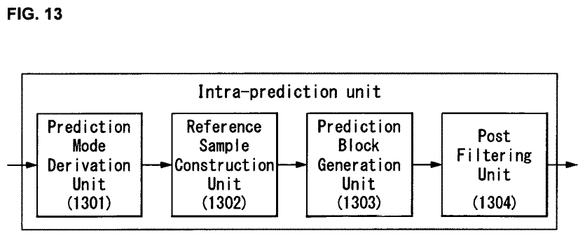

FIG. 13 is a diagram illustrating an intra-prediction unit according to an embodiment of the present invention.

In FIG. 13, for the convenience of description, the intra-prediction units 182 (refer to FIG. 1) and 262 (refer to FIG. 2) are shown as a single block, but the intra-prediction units 182 and 262 may be implemented as a component included in an encoder and/or a decoder.

Referring to FIG. 13, the intra-prediction units 182 and 262 implements the function, the procedure and/or the method proposed in FIG. 1 to FIG. 12 above. Particularly, the intra-prediction units 182 and 262 may include a prediction mode derivation unit 1301, a reference sample construction unit 1302, a prediction block generation unit 1303 and a post filtering unit 1304.

The prediction mode derivation unit 1301 derives an intra-prediction mode of a current block.

In this case, as described in Table 1 and FIG. 6 above, an intra-prediction may have a prediction direction with respect to a position of a reference sample which is used in a prediction depending on a prediction mode.

The reference sample construction unit 1302 constructs reference samples that are going to be used in an intra-prediction of the current block.

In this case, the reference sample construction unit 1302 may check whether the neighboring samples of the current block are used for a prediction, and may construct reference samples that are going to use for an intra-prediction of the current block.

In an intra-prediction, the neighboring samples of the current block (e.g., a unit of encoding, a unit of prediction or a unit of transform) may mean a sample adjacent to a left boundary of the current block of nS×nS size and total 2×nS samples neighboring a bottom-left, and total 2×nS samples neighboring a top-right and a single sample adjacent to a top boundary of the current block.

However, a part of the neighboring samples of the current block still may not be decoded or unavailable. In this case, the reference sample construction unit 1302 may construct reference samples that are going to be used for a prediction by substituting the unavailable samples with available samples.

In addition, the reference sample construction unit 1302 may perform a filtering of a reference sample. In this case, the reference sample construction unit 1302 may perform a filtering of a reference sample based on an intra-prediction mode.

In this case, it may be determined based on a size of the current process block whether to perform a filtering of a reference sample. In addition, the filtering method of one or more reference samples may be predefined, and it may be determined the filtering method of a reference sample by a filtering flag forwarded from an encoder.

The prediction block generation unit 1303 generates a prediction block of the current block by using reference samples according to an intra-prediction mode of the current block.

That is, the prediction block generation unit 1303 generates a prediction block for the current block (i.e., generates a sequence of prediction samples of the current block) based on the intra prediction mode derived by the prediction mode derivation unit 1301 and the reference samples constructed by the reference sample construction unit 1302.

In addition, the prediction block generation unit 1303 may perform a boundary filtering when the current block is encoded in INTRA_DC mode, a vertical mode or a horizontal mode.

In the case that the current block is encoded in the INTRA_DC mode, in order to minimize a discontinuity in the boundary between blocks, the prediction block generation unit 1303 may perform filtering of a left boundary sample (i.e., a sample within a prediction block adjacent to a left boundary of the prediction block, that is, a left end sample within the prediction block) and a top boundary sample (i.e., a sample within a prediction block adjacent to a top boundary of the prediction block, that is, a top end sample within the prediction block).

In addition, the prediction block generation unit 1303 may apply filtering to a left boundary sample or a top boundary sample similar to the INTRA_DC mode even for a vertical mode and a horizontal mode among intra-directional prediction modes. That is, when the intra-prediction direction is a vertical direction, filtering is applied to left boundary samples, and when the intra-prediction direction is a horizontal direction, filtering is applied to top boundary samples.

The prediction block generation unit 1303 performs a post filtering of an intra-predicted block.

In this case, the prediction block generation unit 1303 may determine whether to apply the post filtering to the current block based on the information indicating whether to apply the post filtering received from the encoder.

Otherwise, the prediction block generation unit 1303 may perform the post filtering in the current block when a size of the current block is greater than a predetermined size and/or when an intra-prediction mode is a directional mode.

In addition, when the post filtering is applied to the current block, the reference sample construction unit 1302 may not perform a reference sample filtering, or the prediction block generation unit 1303 may not perform a boundary filtering.

The prediction block generation unit 1303 may generate a prediction block (i.e., a sequence of a prediction sample) of the current block finally by performing a post filtering for each sample within an intra-prediction bock by using the method described in embodiment 1 or embodiment 2 above.

For example, the decoder may perform a post filtering for each prediction sample within the current block by using an adjacent sample and/or a filter coefficient used for the post filtering which is determined according to the filter index received from an encoder as described in embodiment 1 above.

As another example, the decoder may perform a post filtering for each prediction sample within the current block by using an adjacent sample and/or a filter coefficient used for the post filtering which is determined according to an intra-prediction mode of the current block as described in embodiment 2 above. For example, when the intra-prediction mode is a horizontal mode, the post filtering may be performed by using a top adjacent sample of a prediction sample. Otherwise, when the intra-prediction mode is a vertical mode, the post filtering may be performed by using a left adjacent sample of a prediction sample.

In the aforementioned embodiments, the elements and characteristics of the present invention have been combined in specific forms. Each of the elements or characteristics may be considered to be optional unless otherwise described explicitly. Each of the elements or characteristics may be implemented in such a way as to be not combined with other elements or characteristics. Furthermore, some of the elements and/or the characteristics may be combined to form an embodiment of the present invention. The order of the operations described in connection with the embodiments of the present invention may be changed. Some of the elements or characteristics of an embodiment may be included in another embodiment or may be replaced with corresponding elements or characteristics of another embodiment. It is evident that an embodiment may be configured by combining claims not having an explicit citation relation in the claims or may be included as a new claim by amendments after filing an application.

The embodiment of the present invention may be implemented by various means, for example, hardware, firmware, software or a combination of them. In the case of implementations by hardware, an embodiment of the present invention may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers and/or microprocessors.

In the case of an implementation by firmware or software, an embodiment of the present invention may be implemented in the form of a module, procedure, or function for performing the aforementioned functions or operations. Software code may be stored in memory and driven by a processor. The memory may be located inside or outside the processor, and may exchange data with the processor through a variety of known means.

It is evident to those skilled in the art that the present invention may he materialized in other specific forms without departing from the essential characteristics of the present invention. Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

### INDUSTRIAL APPLICABILITY

The aforementioned preferred embodiments of the present invention have been disclosed for illustrative purposes, and those skilled in the art may improve, change, substitute, or add various other embodiments without departing from the technological spirit and scope of the present invention disclosed in the attached claims.

1. A method for processing an image based on an intra-prediction mode, the method comprising:
deriving an intra-prediction mode of a current block;
constructing a reference sample to be used for a prediction of the current block from a neighboring sample of the current block;
generating a prediction block of the current block based on the intra-prediction mode by using the reference sample; and
performing a post filtering by using an adjacent sample of a prediction sample for each prediction sample in the prediction block.

2. The method for processing an image based on an intra-prediction mode of claim 1, further comprising receiving a filter index from an encoding apparatus,
wherein an adjacent sample used in the post filtering and/or a filter coefficient used in the post filtering are/is determined depending on the filter index.

3. The method for processing an image based on an intra-prediction mode of claim 1, wherein an adjacent sample used in the post filtering and/or a filter coefficient used in the post filtering are/is determined depending on the intra-prediction mode.

4. The method for processing an image based on an intra-prediction mode of claim 3, wherein the post filtering is performed by using only a top adjacent sample of the prediction sample, when the intra-prediction mode is a horizontal mode.

5. The method for processing an image based on an intra-prediction mode of claim 3, wherein the post filtering is performed by using only a left adjacent sample of the prediction sample, when the intra-prediction mode is a vertical mode.

6. The method for processing an image based on an intra-prediction mode of claim 3, further comprising receiving information indicating whether to apply the post filtering to the current block,
wherein whether to apply the post filtering to the current block is determined according to the information.

7. The method for processing an image based on an intra-prediction mode of claim 1, wherein the post filtering is performed by using a left adjacent sample and/or a top adjacent sample of the prediction sample.

8. The method for processing an image based on an intra-prediction mode of claim 1, wherein the adjacent sample used for the post filtering is a sample before the post filtering is applied.

9. The method for processing an image based on an intra-prediction mode of claim 1, wherein the adjacent sample used for the post filtering is a sample to which the post filtering is applied.

10. The method for processing an image based on an intra-prediction mode of claim 1, wherein the post filtering is applied to the current block, when a size of the current block is greater than a predetermined size and/or when the intra-prediction mode is a directional mode.

11. The method for processing an image based on an intra-prediction mode of claim 10, wherein a filtering is not applied to the reference sample, when the post filtering is applied to the current block.

12. The method for processing an image based on an intra-prediction mode of claim 10, wherein a filtering is not applied to a left end sample and/or a top end sample within the prediction block even when the intra-prediction mode is DC mode, a horizontal mode or a vertical mode, when the post filtering is applied to the current block.

13. An apparatus for processing an image based on an intra-prediction mode, the apparatus comprising:
a prediction mode derivation unit for deriving an intra-prediction mode of a current block;
a reference sample construction unit for constructing a reference sample to be used for a prediction of the current block from a neighboring sample of the current block;
a prediction block generation unit for generating a prediction block of the current block based on the intra-prediction mode by using the reference sample; and
a post filtering unit for performing a post filtering by using an adjacent sample of a prediction sample for each prediction sample in the prediction block.
